(19) United States
(12) Patent Application Publication
(10) Pub. No.: US 2007/0245755 A1
(43) Pub. Date: Oct. 25, 2007

(54) Air cooling system for parked automobiles

(76) Inventor: Antonio Martin Galvez-Ramos, Wellington, FL (US)

Correspondence Address: ANTONIO MARTIN GALVEZ-RAMOZ, 15105 CEDAR BLUFF PLACE, WELLINGTON, FL, 33414, US

(21) Appl. No.: 11/351,431

(22) Filed: Apr. 24, 2006

(51) Int. Cl. F25B 27/00; B60H 1/32

(52) U.S. Cl. 62/235.1; 62/244

(57) ABSTRACT

The components used in this invention has never been utilized in this special type of arrangement ever before. Solar Panels are basically used on static objects and Car Batteries are usually used to start the engine, but this invention uses these components with the purpose to providing a safety mechanism in a automobile against a common problem that nobody has been able to solve so far, and that is claiming so many lives everyday, Heat Exhaustion inside a parked vehicle under the sun.

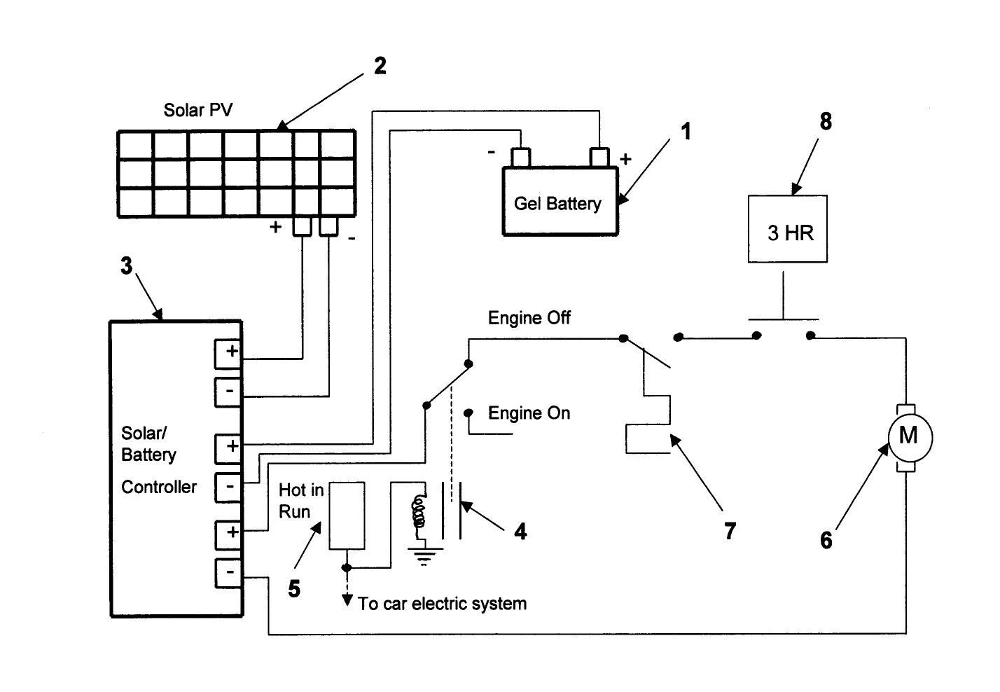

### CROSS REFERENCE TO RELATED APPLICATIONS

“Not Applicable”

### FEDERALLY SPONSORED RESEARCH OR DEVELOPMENT

“Not Applicable”

### SEQUENCE LISTING, A TABLE, OR COMPUTER PROGRAM LISTING, CD APPENDIX

“Not applicable”

### BACKGROUND OF THE INVENTION

This invention pertains to the Electrical Field and falls under the Utility Patent type classification.

A common problem during sunny days is the air overheating inside parked cars where people too often leave their pets, or worse, their kids/babies inside with the intention of coming back within a few minutes, but in some unfortunate cases, the parents get distracted and totally forget about their passengers, not realizing that the air temperature inside the a car exposed to the open sun, even at relatively low temperatures such as 70 F, will rise very fast (within minutes) to the point that it can reach lethal levels to their occupants.

Living in a sunny state such Florida, I have read and seen in the news many cases of heat exhaustion are reported every year, where innocent babies lose their lives, not to mention the pets that follow the same faith.

Having kids and pets of my own, I saw the need to address this problem, and using my experience and knowledge of electrical devices, I came up with a method to cool down the air passenger of a parked vehicle under the sun, when the engine and Air Conditioner is shut down.

### BRIEF SUMMARY OF THE INVENTION

I came up with the idea of a simple method that will be able to cool down the air temperature of a parked automobile, by activating the car's existing motor blower (or a dedicated one if necessary).

Knowing that the battery of the car can not be used because it can be easily depleted, my method contemplates the use of a dedicated High Cycling Battery (Deep Cycle, Solar Gel Battery) in series with a Solar Panel (which does not relies on the car to be running in order to recharge the battery) located on top of the roof of the automobile, and the existing car motor blower.

The Solar Panel will provide the energy to recharge a dedicated battery, independent if the car is running or not, and this dedicated battery will provide the energy required to feed the car Motor Blower, when the automobile engine is shut down.

There could also be a button that the driver will need to push before exiting the vehicle in order to activate the motor blower if the internal car temperature reaches a high value (a thermostat is also be used).

### DETAILED DESCRIPTION OF THE INVENTION

This invention has been designed with the purpose of working when the automobile has been parked and the engine has been turn-off in places where the ambient temperature reaches at least 70 F and the car has been parked under the sun or can be exposed under the sun (moving clouds, moving shadows, etc) and there are passengers left inside, facing potential high extreme hot air temperatures.

Here is how this invention works:

To a regular car we will install a Solar Panel, a Gel Battery, a Solar Controller and some switches, as shown in the attached electrical diagram, in an independent circuitry that feeds the a Motor Blower (a dedicated unit or the existing automobile unit) when the car is parked and the passenger air temperature reaches 85 F (or similar value).

The Solar Panel (2) will go basically installed on top of the roof of the car, and will be able to deliver in sunny conditions over 80 W, 6.5 A to the Solar/Battery Charger Controller (3) that is rated for 12V, 10 A.

This Solar Controller will provide charging voltage to a dedicated 12V, 108 AH Gel Battery (1), which is a High Cycling type (Deep Cycle) , and does not require any type of maintenance and can be installed in any position and does not releases any substantial quantity of gases, because is a sealed type battery.

This Solar Controller will protect the Gel Battery from full discharges, by disconnecting the battery when it reaches the recommended voltage cut off value.

As we do not want to activate this air cooling system by accident, while the car is being driven (at this time the driver can use the standard A/C system or the automobile forced air ventilation system), THREE conditions need to be met in order to active this system.
The first one is that the car is turn off. During normal driving/starting conditions, the Relay (4) will get magnetized, because is connected to the “Hot in Run” point (5) of the automobile, but once the vehicle stops and the driver turns off the engine, the Relay (4) will demagnetized and will move to the “Engine Off” position
The second condition is that the Temperature Relay (7) senses that the passenger air temperature has reached the preset value of 85 F and closes its contacts.
The third condition is that the driver before exiting the car pushes a “Timer Button/Switch” (8). Once this contact is closed, and providing that the other two conditions are met, we will have a closed circuit, and the timer will start counting for the pre-set giving time (3 hours in this case).

This special air cooling circuit will work for 3 hrs or until the driver starts the engine, and therefore opens the circuit by switching the contact position from “Engine Off” to “Engine On”.

After all this 3 conditions are met, the “Blower Motor” (6) (a dedicated or the actual unit from the automobile) will start to pump cool ambient air inside the automobile until the air temperature drops below a preset time that of 75 F (this value could be changed), or the drivers comes back and starts the engine, or the Solar/Battery Controller disconnects the system because the battery has reached the low voltage cut off value of 11.5 V.

The Blower Motor (6) will draw 20 Amps from the Gel Battery, until the above cut off voltage is met, or the electric circuit is open by the starting of the car or the temperature relay.

After this event, the Solar Panel will start to recharge the Gel Battery again through the Solar/Battery Controller. A full charge of a depleted battery will take approximately 12 hrs with a 6 A charge (but the solar panel can supply up to 7.16 A), but it can recharge the Gel Battery to a 90% capacity in about 8 hrs. Hopefully the driver will not leave any pets or kids inside a parked car for more than a few minutes, as this system is not intended to serve in lieu of an Air Conditioner Systems, but only as an Auxiliary Cooling System for parked automobiles.

With a fully re-charged battery, the runtime of the system should be around 4 hrs, and the driver could use it several times during the day.

An extra dedicated Gel Battery (High Cycle type) can be easily installed inside the car next to the engine.

Here is the description of the components:

1.—Gel Battery (1): Normally used in Golf carts, Boats and Cable TV power supplies. These batteries are used when back up power is needed for long times. The car battery is usually a wet type design that basically only works during start. This car battery is not quite designed to provide long run times. By the same token, the Gel Battery it is not designed to start the engine of the automobile, as the high current of the start could destroy the Gel Battery.

The Gel Battery for this application is specially designed to work with a Solar Panel (also known as Solar Batteries), and even though has a Gel electrolyte; it could also be used the AGM type. Both are sealed and Valve Regulated type.

The Solar Gel battery thought for this invention could be the East Penn-Deka, Model 8G31, which is a 12V, 6 cells and with a capacity of 108 AH.

The dimensions are: 12 15/16″ (L); 6¾″ (W), 9⅜″ (H) and 69.5 lbs

2.—Solar Panel (2): Very commonly used these days. This PV arrangement for this application will provide over 80 W during sunny days (up to 123 W). The Sharp Company makes a Solar Panel that can be used for this design. I am talking about the Sharp Solar Panel model ND-L3EJEA (or similar) that is rated for 12VDC Nominal for battery charging applications. The dimensions of 59.02″ (H), 26.06″ (W), 1.81″(D), makes its embedded installation on top of the roof of an automobile very feasible. This solar panel does not release any gases and does not require for the automobile's engine to be running.

3.—Solar Battery Controller (3): The Solar Controller will recharge the battery properly and will also protect the battery from being discharge below the cut off point. Otherwise if this happened, the Gel Battery can get damaged beyond repair.

Several units are available in the market. One of them is the SunSaver 10 made by Morning Star, model SS-10L rated for 12 VDC, 10 A with a Voltage Regulation of 14.1 V and a load disconnect of 11.5VDC.

It weights only 8 oz. and the dimensions are 6″(L), 2.18″ (H), and 1.32″(D).

4.—Magnetic Relay (4): This relay will automatically switches between “Engine Off” and the “Engine On” positions. It will be fed by the car battery.

Many models are available in the market rated for 20 A that is the current that will circulate through the Blower Motor circuit.

5.—Hot at Run Contact (5): This contact is available in any automobile, and will be activated once the vehicle starts. It is connected to the Magnetic Relay (4) in order to activate the Air Cooling System when needed (one of the three conditions needed to be met).

6.—Blower Motor (6): A full size car basically uses a 12V, 20 Amp motor (as in my Cutlas Cierra by GM) that pumps air to the inside of the automobile during A/C activation or just when fresh air is needed (car fan activated).

The same Blower Motor could be used, or a similar dedicated unit could be installed. The Blower Motor for this application is made by Unimotor and the Model # is 11333

7.—Temperature Relay (7): This relay will basically rated for 20 A, closes its contacts once the automobile air temperature reaches a pre-set value (could be 85 F) and will re-open once the air temperature drops below the preset value of approx. 75 F.

If the air temperature is above this preset value, the Blower Motor will continue working.

8.—Timer Button (8): This Timer Button will close its contacts manually by the driver or other person in the vehicle, but will only be fully activated when a the electric circuit is closed. After this, the timer will start to work until gets de-energized (by somebody opening the circuit) or when it reaches the reset time of approx. 3 hrs (or a similar preset value). After this it will open its contacts.

1. This invention provides for an Electrical System not known before, that is intended for cooling down the inside air of a parked automobile during hot days, while the car engine and Air Conditioning are turn off.
